(19) United States
(12) Patent Application Publication
(10) Pub. No.: US 2018/0198125 A1
(43) Pub. Date: Jul. 12, 2018

(54) POLYMER COATED CATHODE MATERIAL, CATHODE AND BATTERY

(71) Applicant: XingFox Energy Technology Co., Ltd., Miaoli (TW)

(72) Inventors: JEI-WEI CHANG, Miaoli (TW); TZU-WEI HUANG, Miaoli (TW)

(21) Appl. No.: 15/853,879

(22) Filed: Dec. 25, 2017

Related U.S. Application Data
(60) Provisional application No. 62/443,858, filed on Jan. 9, 2017.

(51) Int. Cl. H01M 4/60; H01M 4/133; H01M 4/583; H01M 2/14; H01M 4/36; H01M 4/1391

(52) U.S. Cl. CPC H01M 4/602; H01M 4/133; H01M 4/1391; H01M 2/14; H01M 4/366; H01M 4/583

(57) ABSTRACT

A polymer coated cathode material not subject to catastrophic failure through local overheating comprises cathode active material particles and a polymer layer. The polymer layer wraps each cathode active material particle. The polymer coated cathode material has a core-shell structure. The core-shell structure comprises a core and a shell, the core is formed by the cathode active material particle, the shell is formed by the polymer layer. A battery made by the polymer coated cathode material is safer, in that when there is a short circuit, the short circuit only happens locally and a chain reaction is avoided. Only a part of the battery may reach high temperature, preventing an explosion of the battery. A cathode using the polymer coated cathode material, and a battery using the cathode are also provided.

### FIELD

The subject matter herein generally relates to battery power, a polymer coated cathode material, a cathode using the polymer coated cathode material, and a battery using the cathode.

### BACKGROUND

Batteries are typically constructed of solid electrodes, separators, and electrolyte. The solid electrodes include a cathode and an anode. The cathode includes a current collector and a cathode active material coated on the surface of the current collector. As the cathode is immersed in the electrolyte, the cathode active material may disintegrate during charging or discharging, and produce gas such as oxygen, and/or carbon dioxide, especially when the cathode active material is in a high temperature, and/or a high potential. When a short circuit happens, the temperature and the potential of the battery will increase, thus the battery will explode. Thus, a battery with high safety is needed.

### BRIEF DESCRIPTION OF THE DRAWINGS

Implementations of the present disclosure will now be described, by way of example only, with reference to the attached figures.

FIG. 1 present a cross section of a core-shell structure of a polymer coated cathode material in accordance with an exemplary embodiment.

FIG. 2 is a diagrammatic view of a cathode in accordance with an exemplary embodiment.

FIG. 3 is a diagrammatic view of a battery in accordance with an exemplary embodiment.

FIG. 4 s a flowchart of an exemplary embodiment of a method for manufacturing the battery of FIG. 3.

FIG. 5 presents temperature changes and voltage changes of the battery with nail tests.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like. The term “about” when utilized, means “not only includes the numerical value, but also includes numbers closest to the numerical value”.

In an exemplary embodiment, a polymer coated cathode material comprises a plurality of cathode active material particles, and a polymer layer wrapped onto a surface of each cathode active material particle. The cathode active material particle is made of cathode active material. The polymer layer is made of polymer.

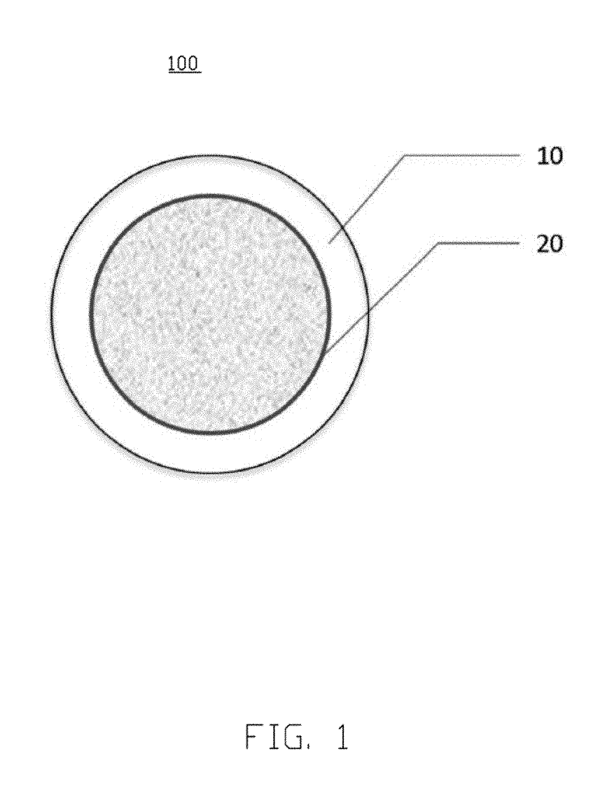

Referring to FIG. 1, the polymer coated cathode material has a core-shell structure 100. The core-shell structure 100 comprises a core 20 and a shell 10. The core 20 is formed by the cathode active material particle. The shell 10 is formed by the polymer layer.

A size of the cathode active material particle can be any size. In at least one exemplary embodiment, a volume median particle size (D50) of the cathode active material particle is in a range of about 0.1 μm to about 100 μm as measured by standard laser diffraction methods. The polymer layer is very thin, and typically does not increase the particle size substantially. Therefore a powder consisting of, or consisting essentially of, the polymer coated cathode material will have a particle size distribution about the same as or at most only slightly larger than the cathode active material particle, and will likewise have a volume median particle size in the range of about 0.1 μm to about 100 μm.

In at least one exemplary embodiment, in the polymer coated cathode material, a ratio of weight of the cathode active material to the polymer is about 100:1 to about 100:0.01. A ratio of weight of the polymer and the cathode material can be changed. It will be appreciated that the effective amount of polymer can vary depending on the characteristics of the cathode active material, for example particle size and particle surface area.

The cathode active material may be an electro-active transition metal oxides comprising lithium. The cathode active material may be selected from LiCoO₂, LiNiO₂, LiMn₂O₄, LiV₃O₈, LiFePO₄, LiMnPO₄, LiCoPO₄, LiVPO₄F, LiNi_{0.5}Mn_{1.5}O₄, LiCo_{0.2}Ni_{0.2}O₂, or any combination thereof. Wherein the LiFePO₄, LiMnPO₄, LiCoPO₄, and LiVPO₄F are olivine structured. The LiNi_{0.5}Mn_{1.5}O₄ is spinel structured. The LiCo_{0.2}Ni_{0.2}O₂ is an oxide of layered structure.

The cathode active material may also be LiNiₓ₁Mn_{y1}Co_{z1}O₂, where x1+y1+z1 is about 1, or L_{1+z2}Ni_{1-x2-y2}Coₓ₂Al_{y2}O₂, where 0<x2<0.3, 0<y2<0.1. The LiNiₓ₁Mn_{y1}Co_{z1}O₂ and the Li _{1+z2}Ni_{1-x2-y2}Coₓ₂Al_{y2}O₂ are oxides of layered structure.

The cathode active material may also be a lithium-containing manganese composite oxide having a spinel structure, such as Liₓ₃Ni_{y3}M_{z3}Mn_{2-y3-z3}O_{4-d}, where 0.03□x3≤1.0, 0.3≤y3≤0.6, 0.01≤z3≤0.18, 0≤d≤0.3, M may be Cr, Fe, Co, Li, Al, Ga, Nb, Mo, Ti, Zr, Mg, Zn, V, or Cu. In at least one exemplary embodiment in the above formula, 0.38≤y3≤0.48, 0.03≤z3≤0.12, and 0≤d≤0.1. In at least one exemplary embodiment in the above formula, M is Li, Cr, Fe, Co or Ga. In at least one exemplary embodiment, the lithium-containing manganese composite oxide having a spinel structure may also comprise spinel-layered composites which contain a manganese-containing spinel component and a lithium rich layered structure.

The cathode active material may also be LiNiₓ₄Co_{y4}Mn_{z4}L_{1-x4-y4-z4}O₂, where 0≤x4≤1, 0≤y4≤1, 0≤z4≤1, the L may be Al, Mg, Sr, Ti, Ca, Zn, Si, or Fe.

The cathode active material may also be LiCoₓ₅L₁₋ₓ₅O₂, where 0≤x5≤1, the L may be Al, Mg, Sr, Ti, Ca, Zn, Si, or Fe.

The polymer is not limited in materials or type or composition and can be any suitable polyimide composition.

In at least one exemplary embodiment, the polymer may be a high-molecular polymer.

In at least one exemplary embodiment, the high-molecular polymer may be a thermosetting polymer. A thermosetting temperature of the thermosetting polymer is from about 50 degrees Celsius to about 200 degrees Celsius. In an alternative embodiment, the thermosetting temperature of the thermosetting polymer is from about 80 degrees Celsius to about 170 degrees Celsius. Using different cathode active materials, an appropriate thermosetting temperature can be chosen as needed.

In at least one exemplary embodiment, the thermosetting polymer is polyimide. The polyimide is made of an imide. The polyimide is formed by a method, for example by dehydration the imide at elevated temperature, well known in the art.

The imide may be selected from N,N′-ethylene Bismaleimide, N,N′-butene Bismaleimide, N,N′-six methylene Bismaleimide, N,N′-m-phenylenedimaleimide, N,N′-benzenes Bismaleimide, N,N′-4,4-two phenyl methane Bismaleimide, N,N′-4,4-diphenyl ether Bismaleimide, N,N′-4,4-two Diphenyl Sulfoxide Bismaleimide, N,N′-4,4-dicyclohexyl methane Bismaleimide, N,N′-phenyldimethyl Bismaleimide, N,N′-(4,4-methylene two phenyl) Bismaleimide, N,N′-two phenyl cyclohexane Bimaleimide, or any combination thereof.

In at least one exemplary embodiment, the polyimide comprises, consists essentially of, or consists of monomers pyromellitic dianhydride and oxydianiline.

The polymer coated cathode material may be formed by coating the polymer on the surface of the cathode active material particle, to form a polymer layer wrapped onto the surface of the cathode active material particle. The cathode active material particle can be coated with precursor by any suitable coating process. Such processes are well known to those skilled in the art. Generally, a solution of polyimide precursor (imide) in suitable solvent is applied to the cathode active material, so that the surface of the particles is evenly and completely coated with the imide solution. The solvent is then removed and the imide is heated to convert (cure) it to polyimide. The presence of polyimide on the surface of the cathode active material particle can be detected by standard techniques such as infrared spectroscopy.

The solvent can be any one of various solvents commonly used for such purpose. Examples of the solvent include a chain carbonate such as dimethyl carbonate, ethyl methyl carbonate, diethyl carbonate or dipropyl carbonate, a cyclic carbonate such as ethylene carbonate, propylene carbonate or butylene carbonate, dimethoxyethane, diethoxyethane, a fatty acid ester derivative, gamma-butyrolactone, N-methylpyrrolidone (NMP), acetone, or water. The solvent may also be a combination of two or more of these.

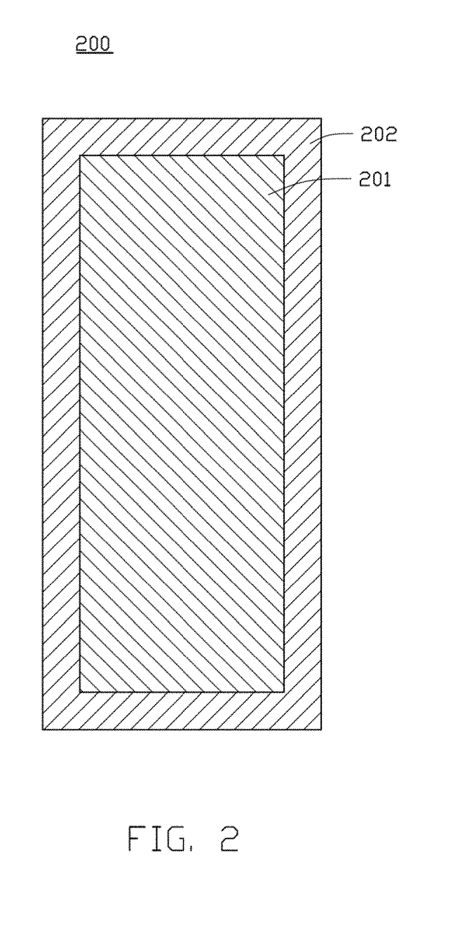

FIG. 2 illustrates a cathode 200 including a current collector 201, and a cathode material layer 202 on a surface of the current collector 201. The cathode material layer 202 comprises the polymer coated cathode material, and a binder dispersed in the polymer coated cathode material.

The current collector 201 refers to a structural part of an electrode assembly whose primary purpose is to conduct electricity between the actual working part of the electrode, and the terminals of an electrochemical cell. The current collector material may be any one of various materials commonly used in the art, for example a copper foil or an aluminum foil, but is not limited thereto.

The cathode material layer 202 further comprises a binder. The binder is dispersed in the polymer coated cathode material. The binder is configured to bind the cathode active material particles together, and attach the polymer coated cathode material to the surface of the current collector 201, to form the cathode material layer 202.

In at least one exemplary embodiment, the binder may be selected from polyvinylalcohol, carboxymethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, polyvinylidene fluoride (PVDF), or any combination thereof.

In at least one exemplary embodiment, the binder is typically present in an amount of about 0.1 wt % to about 10 wt % based on the weight of the polymer coated cathode material.

The cathode material layer 202 may further include a conductive agent. The conductive agent provides conductivity to the cathode 200 and may be any one of various materials that do not cause any deleterious effects and that conduct electrons. Examples of the conductive agent includes a carbonaceous material, such as natural graphite, artificial graphite, flaky graphite, carbon black, acetylene black, ketjen black, denka black, carbon fiber, carbon nanotube or graphene. The agent may also be a metallic material, such as copper powder or fiber, nickel powder or fiber, aluminum powder or fiber, or silver powder or fiber; a conductive polymer such as a polyphenylene derivative, and mixtures thereof.

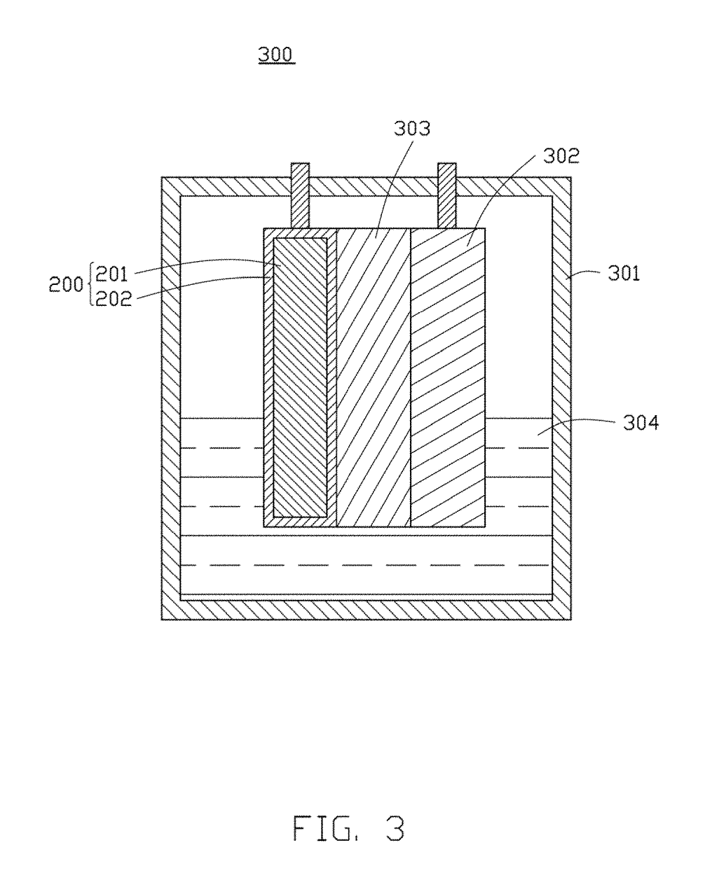

FIG. 3 illustrates a battery 300 including a housing 301, a cathode 200, an anode 302, a separator 303 secured between the cathode 200 and the anode 302, and an electrolyte 304. The cathode 200, the anode 302, the separator 303 and the electrolyte 304 are mounted in the housing 301. At least a portion of the cathode 200, and at least a portion of the anode 302 are immersed in the electrolyte 304.

The cathode 200 of the battery 300 includes a current collector 201, and a cathode material layer 202 attached on a surface of the current collector 201. The cathode material layer 202 comprises the polymer coated cathode material, and a binder dispersed in the polymer coated cathode material. The polymer coated cathode material comprises a plurality of cathode active material particles, and a polymer layer wrapped onto a surface of each cathode active material particle. Thus the accessibility of the electrolyte 304 and the cathode active material is decreased. When there is a short circuit in the battery 300, then the short circuit is localized and only happens in a part of the battery 300. A chain reaction will thus not happen. Thus, only a part of the battery 300 may experience a relatively high temperature (usually between 25 to 50° C.), preventing an explosion of the battery.

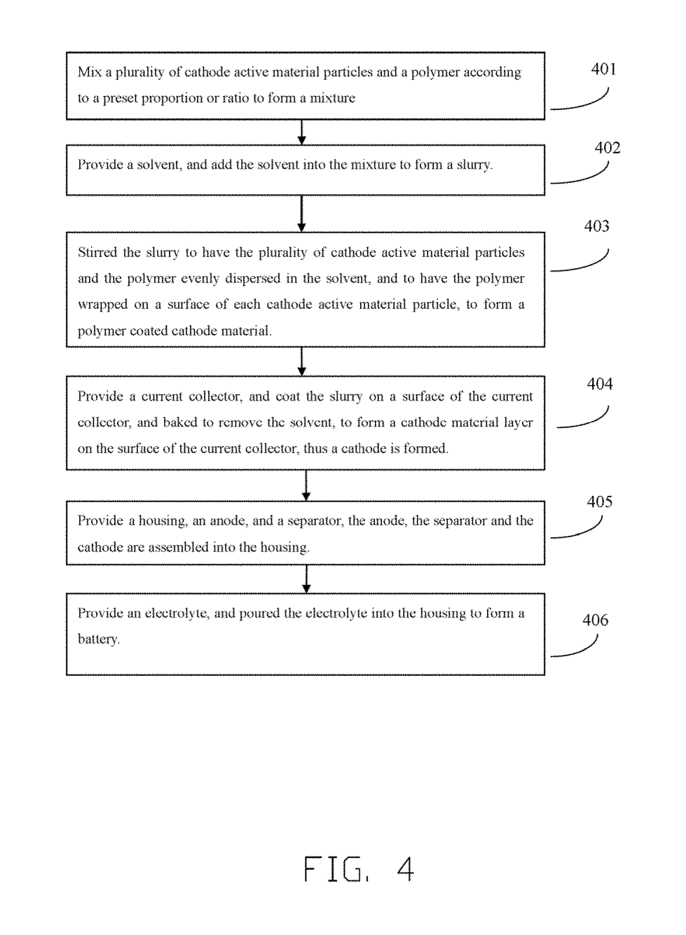

FIG. 4 illustrates a flowchart of a method for making the battery 300 in an exemplary embodiment. The exemplary method is provided by way of example, as there are a variety of ways to carry out the method. Each block shown in the figure represents one or more processes, methods, or subroutines, carried out in the exemplary method. Furthermore, the illustrated order of blocks is by example only and the order of the blocks can change. Additional blocks may be added or fewer blocks may be utilized, without departing from this disclosure. The exemplary method may begin at block 401.

At block 401, a plurality of cathode active material particles and a polymer are mixed according to a preset proportion or ratio, to form a mixture.

At block 402, a solvent is provided and added into the mixture to form a slurry.

At block 403, the slurry is stirred to disperse the cathode active material particles and the polymer evenly in the solvent, and to wrap the polymer onto a surface of each cathode active material particle, to form a polymer coated cathode material.

At block 404, a current collector 201 is provided, and the slurry is coated on a surface of the current collector 201. The collector 201 is baked to remove the solvent, to form a cathode material layer 202 on the surface of the current collector 201, thus a cathode 200 is formed.

At block 405, a housing 301, an anode 302, and a separator 303 are provided, the anode 302, the separator 303 and the cathode 200 are assembled into the housing 301.

At block 406, an electrolyte 304 is provided, and poured into the housing 301 to form a battery 300.

When the polymer is a polyimide, at block 401, the plurality of cathode active material particles are mixed with imide according to a preset proportion or ratio, to form a mixture. At block 403, the slurry is stirred and heated at a temperature of about 65 degrees Celsius to about 150 degrees Celsius for about 0.5 hours to about 10 hours, to convert (cure) the imide to polyimide, thus to form a polymer layer on each cathode active material particle, to form a polymer coated cathode material.

### EXAMPLE

The cathode active material particle of the polymer coated cathode material was made of LiCoO₂, the polymer layer of the polymer coated cathode material was made of polyimide, the polyimide was made of N,N′-m-phenylenedimaleimide. The ratio of weight of the cathode active material to the polymer is about 68.1:0.21.

The polymer coated cathode material was coated on a surface of a current collector 201, to form a cathode 200. The current collector 201 is an aluminum foil.

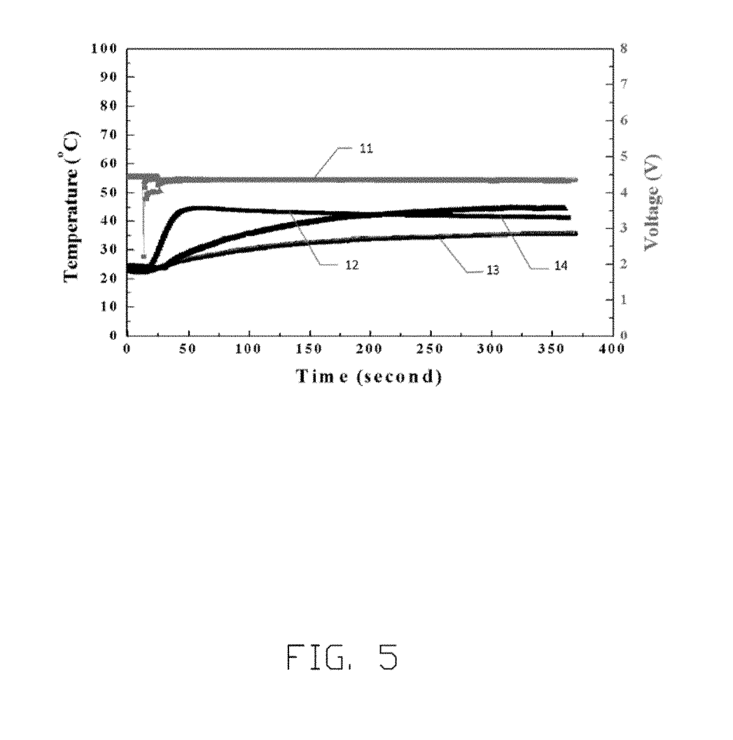

Three batteries 300 were made by the cathode 200. The three batteries 300 were subjected to a nail test, to test the voltage changes and temperature changes when working. The test results are shown in FIG. 5. The curve 11 shows the voltage changes of the three batteries 300, and the curves 12, 13, and 14 show the temperature changes of the three batteries 300.

In FIG. 5, the curve 11 illustrates that the voltage of the three batteries 300 rapidly decreases at an initial stage of the nail test, and then reaches and keeps a normal voltage. It is clear that a short circuit will not happen, and the first sample would not catch fire or explode. The three batteries 300 remain stable.

In FIG. 5, the curves 12, 13, and 14 illustrate that short circuit will not happen, and the three batteries 300 will not catch fire or explode. The temperature of the three batteries 300 does increase, but in a safe range. The polymer coated cathode material in the present disclosure and the batteries 300 having the polymer coated cathode material have better safety characteristics.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A polymer coated cathode material comprising:
a plurality of cathode active material particles;
wherein each cathode active material particle is coated with polymer.

2. The polymer coated cathode material of claim 1, wherein the polymer coated cathode material has a core-shell structure, the core-shell structure comprises a core and a shell, the core is formed by the cathode active material particle, the shell is formed by the polymer layer.

3. The polymer coated cathode material of claim 1, wherein a volume median particle size of each cathode active material particle is in a range of about 0.1 μm to about 100 μm.

4. The polymer coated cathode material of claim 1, wherein a ratio of weight of the cathode active material to the polymer is about 100:1 to about 100:0.01.

5. The polymer coated cathode material of claim 1, wherein the cathode active material particle is made of cathode active material, the cathode active material is selected from LiCoO₂, LiNiO₂, LiMn₂O₄, LiV₃O₈, LiFePO₄, LiMnPO₄, LiCoPO₄, LiVPO₄F, LiNi_{0.5}Mn_{1.5}O₄, LiCo_{0.2}Ni_{0.2}O₂, LiNiₓ₁Mn_{y1}Co_{z1}O₂, Li_{1+z2}Ni_{1-x2-y2}Coₓ₂Al_{y2}O₂, or Liₓ₃Ni_{y3}M_{z3}Mn_{2-y3-z3}O_{4-d}, LiNiₓ₄Co_{y4}Mn_{z4}L_{1-x4-y4-z4}O₂, LiCoₓ₅L₁₋ₓ₅O₂, and any combination thereof, where x1+y1+z1 is about 1; 0<x2<0.3, 0<y2<0.1; 0.03□x3≤1.0, 0.3≤y3≤0.6, 0.01≤z3≤0.18, 0≤d≤0.3, M is Cr, Fe, Co, Li, Al, Ga, Nb, Mo, Ti, Zr, Mg, Zn, V, or Cu; 0≤x4≤1, 0≤y4≤1, 0≤z4≤1, L is Al, Mg, Sr, Ti, Ca, Zn, Si, or Fe; 0≤x5≤1.

6. The polymer coated cathode material of claim 1, wherein the polymer layer is made of thermosetting polymer, a thermosetting temperature of the thermosetting polymer is from about 50 degrees Celsius to about 200 degrees Celsius.

7. The polymer coated cathode material of claim 6, wherein the thermosetting polymer is polyimide, the polyimide is made of an imide, the imide is selected from N,N-ethylene Bismaleimide, N,N′-butene Bismaleimide, N,N′ -six methylene Bismaleimide, N,N′-m-phenylenedimaleimide, N,N′-benzenes Bismaleimide, N,N′-4,4-two phenyl methane Bismaleimide, N,N′-4,4-diphenyl ether Bismaleimide, N,N′-4,4-two Diphenyl Sulfoxide Bismaleimide, N,N′-4,4-dicyclohexyl methane Bismaleimide, N,N′-phenyldimethyl Bismaleimide, N,N′-(4,4-methylene two phenyl) Bismaleimide, N,N′-two phenyl cyclohexane Bimaleimide, and any combination thereof.

8. A cathode comprising:
a current collector; and
a cathode material layer attached on a surface of the current collector, the material layer comprises a polymer coated cathode material, the polymer coated cathode material comprising:
a plurality of cathode active material particles;
wherein each cathode active material particle is coated with polymer.

9. The cathode of claim 8, wherein the polymer coated cathode material has a core-shell structure, the core-shell structure comprises a core and a shell, the core is formed by the cathode active material particle, the shell is formed by the polymer layer.

10. The cathode of claim 8, wherein a volume median particle size of each cathode active material particle is in a range of about 0.1 μm to about 100 μm.

11. The cathode of claim 8, wherein a ratio of weight of the cathode active material to the polymer is about 100:1 to about 100:0.01.

12. The cathode of claim 8, wherein the cathode active material particle is made of cathode active material, the cathode active material is selected from LiCoO₂, LiNiO₂, LiMn₂O₄, LiV₃O₈, LiFePO₄, LiMnPO₄, LiCoPO₄, LiVPO₄F, LiNi_{0.5}Mn_{1.5}O₄, LiCO_{0.2}Ni_{0.2}O₂, LiNiₓ₁Mn_{y1}Co_{z1}O₂, Li_{1+z2}Ni_{1-x2-y2}Coₓ₂Al_{y2}O₂, or Liₓ₃Ni_{y3}M_{z3}Mn_{2-y3-z3}O_{4-d}, LiNiₓ₄Co_{y4}Mn_{z4}L_{1-x4-y4-z4}O₂, LiCoₓ₅L₁₋ₓ₅O₂, and any combination thereof, where x1+y1+z1 is about 1; 0<x2<0.3, 0<y2<0.1; 0.03□x3≤1.0, 0.3≤y3≤0.6, 0.01≤z3≤0.18, 0≤d≤0.3, M is Cr, Fe, Co, Li, Al, Ga, Nb, Mo, Ti, Zr, Mg, Zn, V, or Cu; 0≤x4≤1, 0≤y4≤1, 0≤z4≤1, L is Al, Mg, Sr, Ti, Ca, Zn, Si, or Fe; 0≤x5≤1.

13. The cathode of claim 8, wherein the polymer layer is made of thermosetting polymer, a thermosetting temperature of the thermosetting polymer is from about 50 degrees Celsius to about 200 degrees Celsius.

14. The cathode of claim 13, wherein the thermosetting polymer is polyimide, the polyimide is made of an imide, the imide is selected from N,N-ethylene Bismaleimide, N,N′-butene Bismaleimide, N,N′-six methylene Bismaleimide, N,N′-m-phenylenedimaleimide, N,N′-benzenes Bismaleimide, N,N′-4,4-two phenyl methane Bismaleimide, N,N′-4,4-diphenyl ether Bismaleimide, N,N′-4,4-two Diphenyl Sulfoxide Bismaleimide, N,N′-4,4-dicyclohexyl methane Bismaleimide, N,N′-phenyldimethyl Bismaleimide, N,N′-(4,4-methylene two phenyl) Bismaleimide, N,N′-two phenyl cyclohexane Bimaleimide, and any combination thereof.

15. A battery comprising:
a housing;
an anode mounted in the housing;
a separator mounted in the housing;
an electrolyte received in the housing; and
a cathode mounted in the housing, the cathode comprising:
a current collector; and
a cathode material layer attached on a surface of the current collector, the material layer comprises a polymer coated cathode material, the polymer coated cathode material comprising:
a plurality of cathode active material particles;
wherein each cathode active material particle is coated with polymer.

16. The battery of claim 15, wherein the polymer coated cathode material has a core-shell structure, the core-shell structure comprises a core and a shell, the core is formed by the cathode active material particle, the shell is formed by the polymer layer.

17. The battery of claim 15, wherein a volume median particle size of each cathode active material particle is in a range of about 0.1 μm to about 100 μm.

18. The battery of claim 15, wherein a ratio of weight of the cathode active material to the polymer is about 100:1 to about 100:0.01.

19. The battery of claim 15, wherein the cathode active material particle is made of cathode active material, the cathode active material is selected from LiCoO₂, LiNiO₂, LiMn₂O₄, LiV₃O₈, LiFePO₄, LiMnPO₄, LiCoPO₄, LiVPO₄F, LiNi_{0.5}Mn_{1.5}O₄, LiCO_{0.2}Ni_{0.2}O₂, LiNiₓ₁Mn_{y1}Co_{z1}O₂, Li_{1+z2}Ni_{1-x2-y2}Coₓ₂Al_{y2}O₂, or Lₓ₃Ni_{y3}M_{z3}Mn_{2-y3-z3}O_{4-d}, LiNiₓ₄Co_{y4}Mn_{z4}L_{1-x4-y4-z4}O₂, LiCoₓ₅L₁₋₅O₂, and any combination thereof, where x1+y1+z1 is about 1; 0<x2<0.3, 0<y2<0.1; 0.03□x3≤1.0, 0.3≤y3≤0.6, 0.01≤z3≤0.18, 0≤d≤0.3, M is Cr, Fe, Co, Li, Al, Ga, Nb, Mo, Ti, Zr, Mg, Zn, V, or Cu; 0≤x4≤1, 0≤y4≤1, 0≤z4≤1, L is Al, Mg, Sr, Ti, Ca, Zn, Si, or Fe; 0≤x5≤1.

20. The battery of claim 15, wherein the polymer layer is made of polyimide, the polyimide is made of an imide, the imide is selected from N,N-ethylene Bismaleimide, N,N′-butene Bismaleimide, N,N′-six methylene Bismaleimide, N,N′-m-phenylenedimaleimide, N,N′-benzenes Bismaleimide, N,N′-4,4-two phenyl methane Bismaleimide, N,N′-4,4-diphenyl ether Bismaleimide, N,N′-4,4-two Diphenyl Sulfoxide Bismaleimide, N,N′-4,4-dicyclohexyl methane Bismaleimide, N,N′-phenyldimethyl Bismaleimide, N,N′-(4,4-methylene two phenyl) Bismaleimide, N,N′-two phenyl cyclohexane Bimaleimide, and any combination thereof.
